(19) United States
(12) Patent Application Publication
(10) Pub. No.: US 2002/0070187 A1
(43) Pub. Date: Jun. 13, 2002

(54) Automotive crane

(75) Inventor: Hans-Dieter Willim, Ulm (DE)

Correspondence Address: Rocco S. Barrese, Esq., DILWORTH & BARRESE, 333 Earle Ovington Boulevard, Uniondale, NY, 11553, US

(73) Assignee: Liebherr-Werk Ehingen GmbH

(21) Appl. No.: 10/020,823

(22) Filed: Dec. 12, 2001

(30) Foreign Application Priority Data
Dec. 12, 2000 (DE) 200 20974.4

(51) Int. Cl. B66C 23/68

(52) U.S. Cl. 212/299

(57) ABSTRACT

This invention concerns a vehicular crane with a telescoping boom attached to its bed in such a manner that it can luff, as well as guying for the telescoping boom, which has a guy support on the back of the telescoping boom, guying cabling from the guy support to a head or collar of a telescoping boom section, as well as at least one winch to tension the guy cabling, where the guy support has two V-shaped, spreadable legs whose ends on the boom side are mounted to allow them to pivot and whose ends opposite the telescoping boom can each be connected to a guy cable. According to the invention, the vehicular crane is characterized by the fact that the guy support is designed to be free of cross beams between its two legs away from the outer ends.

This invention concerns a vehicular crane with telescoping boom that is capable of luffing, mounted on its bed, and a guy support for the telescoping boom, guy cabling from the guy support to a head or collar of a boom extension that telescopes out, as well as a winch to tension the guy cabling, where the guy support has two V-shaped legs whose ends on the boom side are mounted to allow them to rotate and whose ends opposite the telescoping boom can each be connected to a guy cable.

In the vehicular crane known from BE 196 06 109 A1, the guying stiffens the telescoping boom at its vertical midpoint and counteracts a bending of the telescoping boom at this point. For example, when wind loads are applied to the telescoping boom, it is subjected to bending pressures in a transverse plane. In order to guy against this as well, in DE 200 02 748 U, a spatial guying of the telescoping boom was suggested. The guy support consists of two V-shaped, spreadable legs, by means of which two guy cables can be tensioned at a distance from the side of the vertical central plane and brought to the head piece of a boom extension that can be moved outward. For one thing, this prevents a bending of the telescoping boom resulting from forces affecting a load hook. For another thing, the boom is stiffened against sideward bending as a result of transverse forces.

In order to spread the legs of the guy support in the shape of a V, a knee-lever mechanism is provided in this known guy support that can force the ends of the legs that are away from the telescoping boom together or apart. The transverse effort caused by the knee-lever mechanism of the leg of the guy support provides the support with its stiffness against radial movement of the leg, so that the guy cables can be guided in a stable manner into the extended position from the vertical center plane. This knee-lever mechanism is, however, relatively complex. It has many parts and increases the weight

The problem to be solved by this invention is therefore to create an improved vehicular crane of the type mentioned at the beginning, which avoids disadvantages from the state of technology and further develops the vehicular crane in an advantageous manner. Especially, an effective spatial guying of the telescoping boom, both against lifting and transverse loading, is to be provided without a complex and complicated mechanism.

This problem is solved, according to the invention, by a vehicular crane in accordance with claim 1. Advantageous embodiments of the invention are the subject of the subsidiary claims.

The guy support is therefore free of transverse force between the far ends of its two legs. The legs of the guy support extend freely outward from the foot of the guy support and are connected there only to the guy cabling. The separate legs are dimensioned in such a manner that each of the legs is capable of safely absorbing the forces that result from the guying and therefore holding the guy cables in the position desired, spread outward to the side. As a result of the removal of the transverse efforts, the adjusting block and the lifting cable can pass unhindered in any boom position.

In a further development of the invention, the lateral rotatability of the guy support leg takes place around two axes. Preferably, the guy support can be rotated with both its legs around an axis transverse to the longitudinal axis of the telescoping boom, so that the guy frame can be rotated into a transport position lying on the telescoping boom. Secondly, in an advantageous manner, both legs can be moved around one or two axes parallel to the longitudinal direction of the telescoping boom, so that the V-shaped spread angle between the two legs can be changed.

In an advantageous manner, the two legs of the guy support may be hinged with the ends toward the boom rotatable on a support piece, which in turn is hinged to the boom. The support piece can be rotated relative to the telescoping boom around an axis perpendicular to the vertical longitudinal plane of the telescoping boom. The legs of the guy support can be rotated relative to the support piece around axes of rotation parallel to the vertical longitudinal plane of the telescoping boom. Preferably, the two legs of the guy support can be rotated only around one axis each. As a result, in an advantageous manner, the legs of the guy support can be erected together with the support piece relative to the telescoping boom.

According to an advantageous embodiment of the invention, the hinge points of both legs on the support piece are at a distance from its hinge point on the telescoping boom. The support piece may have a height that approximately corresponds to the diameter of the telescoping boom. It is, however, also possible to arrange the rotational axes of the two legs directly on the telescoping boom. The above-described embodiment with a support piece with a certain height, however, has advantages in erecting the guy support relative to the telescoping boom.

The support piece can be designed differently. According to an advantageous embodiment of the invention, it is built up as a stiff frame of various struts. The frame can be rectangular in form, the hinge points between the support piece and the telescoping boom or between the support piece and the guy frame legs can be placed at the four corners.

In further development of the invention, the vehicular crane has a spreader to adjust the spread angle between the two guy frame legs. The two legs can be moved apart in order to reach the spatial guying. They can, however, also be brought together, especially in order to store the guy frame on the telescoping boom in a space-saving arrangement, for example, for the transport of the vehicular crane. In addition to this, the adjustment of the spread angle can be used to set the relationship between guying against vertical forces and guying against transverse forces. Especially, a pair of pressure cylinders can be provided to spread the two guy support legs, which are connected to the movable support piece and, on the other side, each is hinged to one of the two guy support legs. Radial forces on the guy support legs, which tend to force them apart or together, are transferred directly to the support piece. No stresses are transferred to the telescoping boom as such.

The design of the spreading device using pressure cylinders is substantially simpler than a knee-lever mechanism between the two guy support legs. The guy support legs can be moved rapidly. On the other hand, they still maintain the necessary stiffness against radial movements.

In principle, the spreading cylinders can also be hinged on the telescoping boom. If the spreading cylinders are hinged on the support piece, these can, however, be rotated advantageously together with the two legs of the guy support, for example, in order to erect the guy frame, or the entire guying equipment can be included in a single displacement of an auxiliary crane.

In a further development of the invention, a pressure cylinder unit can be provided as an erection device for the adjustment of an erection angle between the guy support and the longitudinal axis of the telescoping boom, which, on one end, is pivoted to the telescoping boom and at the other end to the support piece. As a result, the support piece can be pushed into an upright position. The two legs pivoted on it are automatically carried along. It would also be fundamentally possible to attach the erection device to the legs of the guy support itself It is advantageous, however, for the erection device to push the frame of the support piece up with the legs pivoted to it. Especially a pair of pressure cylinders can be provided that are pivoted to the sides of the telescoping boom and pivoted on their other ends to the support piece. By pivoting the pressure cylinders to the lower side of the telescoping boom, favorable leverage conditions can be obtained, even when the guy support is lying in its transport position on the back of the telescoping boom.

In the case of a multi-stage boom, the guy cables can be attached both to the individual collars of the telescoping sections or to the boom head.

In a preferred embodiment of the invention, the guy cables are bolted to different collars of the individual telescoping sections or directly to the telescoping boom head piece, depending upon the length of the boom and how it operates, in order to obtain an optimum bending line in the boom.

If, in tipped luffing operation, or with a fixed tip, one or more lattice extensions are bolted onto the head of the telescoping boom, then it is preferable to attach the guying to one of the extension pieces.

In a further embodiment of the invention, the guy cables that lead from the guy support to the head of the boom can be attached to a transverse support that has two other points at a distance from the side of the boom for the guy cables. The guy cables therefore lie not directly on the boom but rather they are kept at a distance by the transverse support.

According to an alternative advantageous embodiment of the invention, the guy cables are brought to the head of the corresponding extended boom or to a luffing tip adapter attached to it and fastened there. They run together in a V-shape to the tip of the boom. As a result, force can be applied directly to the telescoping boom.

Separate winches can be provided to tension the guy cables, especially a winch can be provided on the end of each leg of the guy support to tension each guy cable. The winches can especially be placed on the end of the legs opposite the telescoping boom. As a result of this, pulleys and the like can be dispensed with.

In order to decrease impediments to the mobility of the telescoping boom due to the guy support extending on its back, it can be provided that the legs of the guy support are of variable length. By this means, the backward tip radius of the telescoping boom can be improved. Especially, telescoping supports can be provided as legs.

According to a further preferred embodiment of the invention, it is provided that the outer ends of the guy support legs are guyed from the bed of the vehicular crane, the front point or the pivot axis of the pivot section of the telescoping boom or the lower area of the pivot section. If the legs of the guy support are brought in from their greatest length at which they are approximately perpendicular to the telescoping boom to a shorter length, or if they are telescoped in, the guy support assumes a position tilted toward the tip of the boom. In this equipment condition, while the lifting capacity is reduced, as a result of the corresponding tilting of the guy support, a relatively good stabilizing leverage is, however, still achieved. In addition to this, this embodiment, in spite of the shortened length of the guy frame, makes it possible to maintain the predetermined or constant length of the guy cables or rods or chain guying to the foot of the boom, so that an adjusting device for changing the length of the guying can be dispensed with.

In the following, using preferred sample embodiments and associated drawings, the invention will be explained in greater detail. The drawings show:

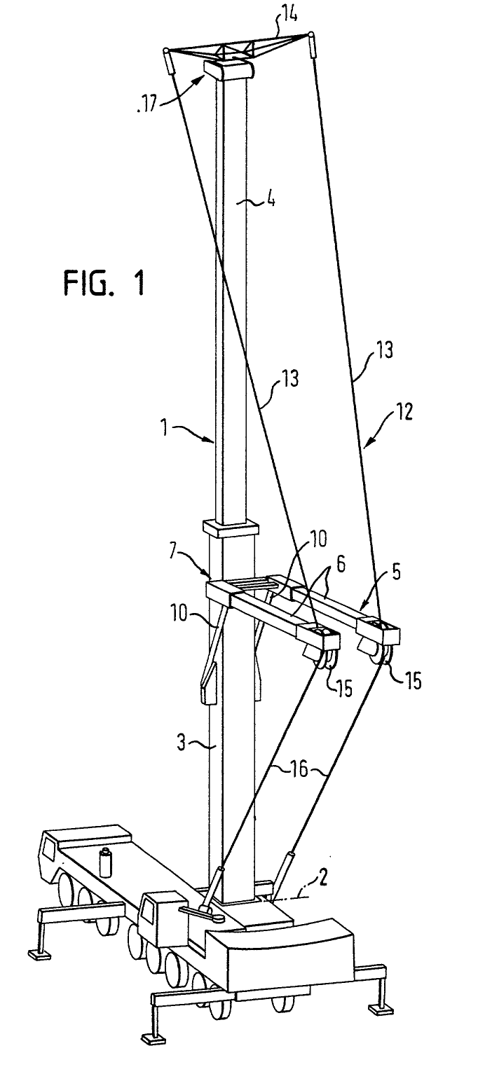

FIG. 1 A perspective view of a vehicular crane, according to a preferred embodiment of the invention, where the telescoping boom is shown in extended erected position with spatial guying, where the legs of the guy support are represented on the back of the telescoping boom in their position nearest each other.

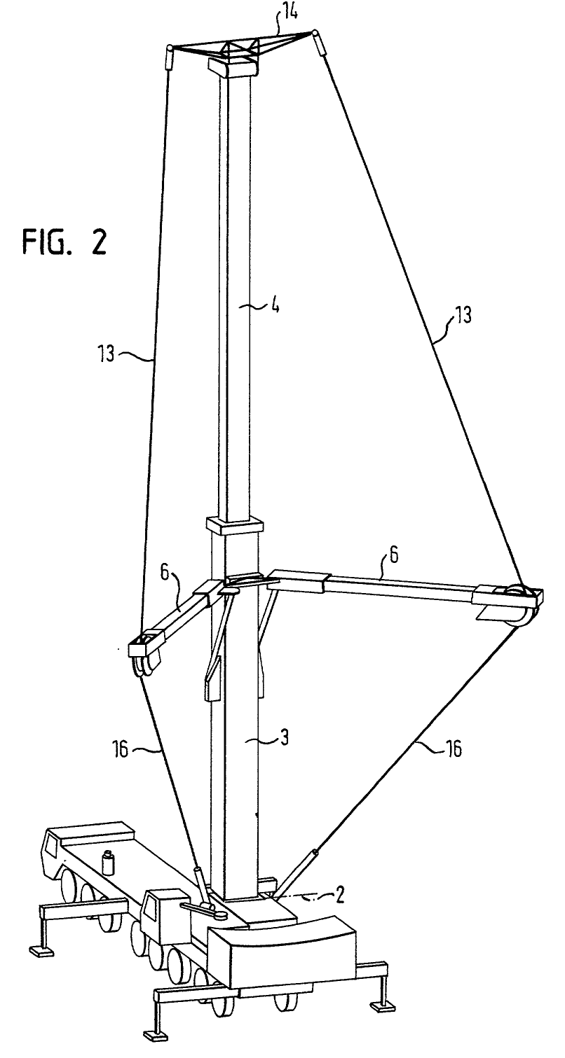

FIG. 2 A perspective representation of the vehicular crane similar to FIG. 1, where the legs of the guy support are moved apart from each other in a V-shape,

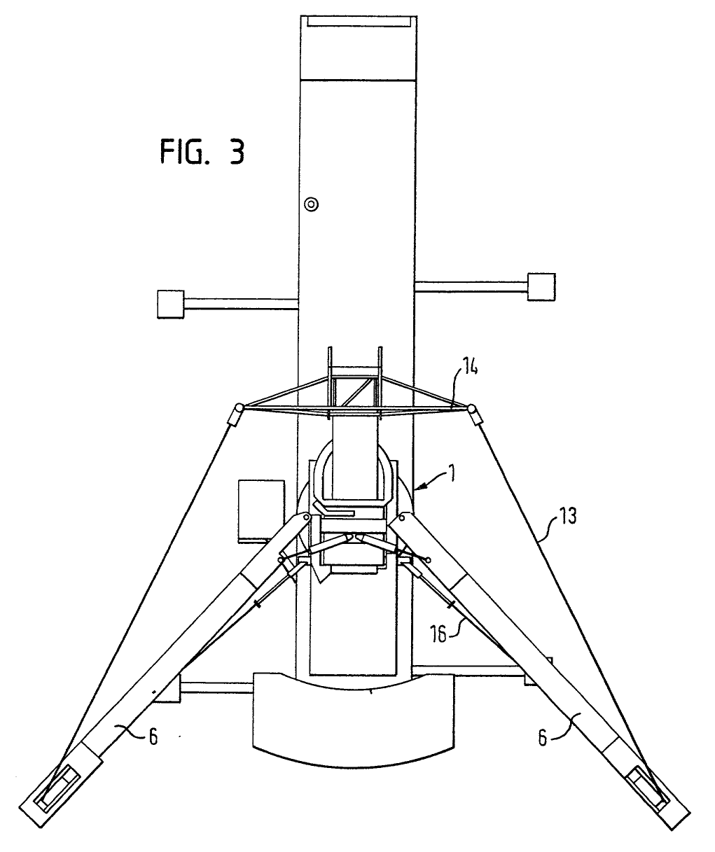

FIG. 3 A top-view of the vehicular crane from FIG. 2,

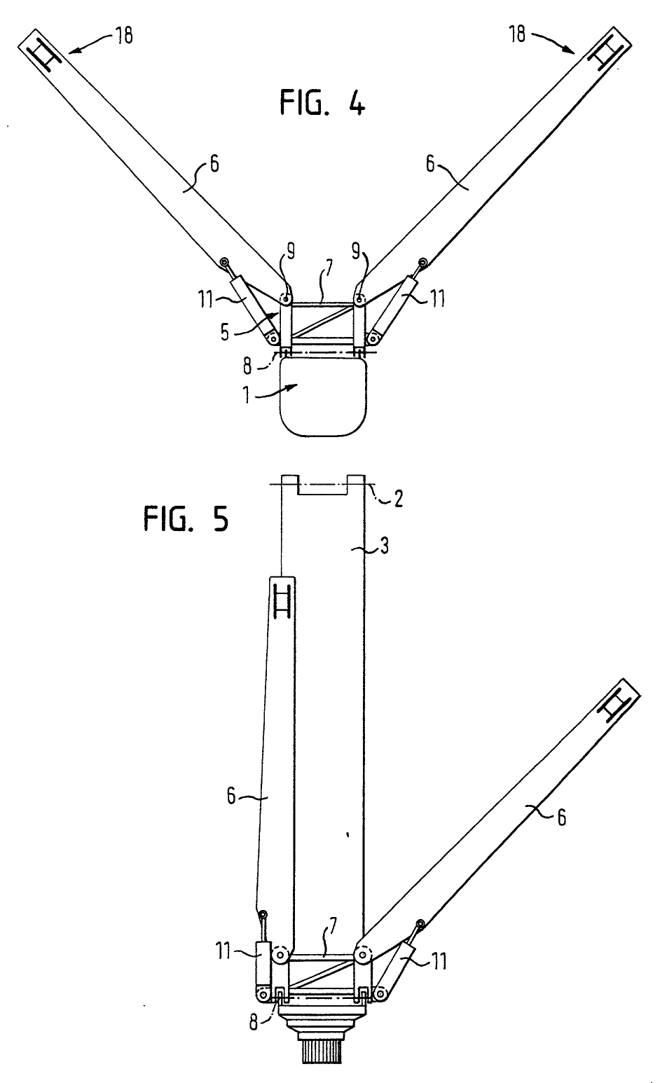

FIG. 4 A partial representation of the guy support, which is shown in the erected and spread position to the telescoping boom,

FIG. 5 A partial representation of the guy support in the non-erect position, where one leg of the guy support is shown swung inward into its transport position, and the other leg of the guy support in its spread position, and

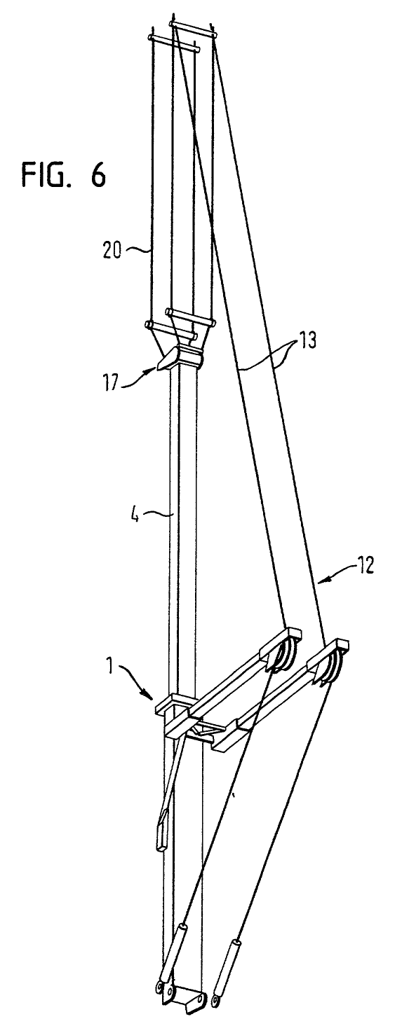

FIG. 6 A perspective partial view of a telescoping boom, according to a further embodiment of the invention, in which an extension is fastened to the head of the boom and guyed with the guy cables.

The vehicular crane represented in the drawing consists of an ordinary vehicle chassis on which a bed capable of rotating around a vertical axis is installed. On the bed, a telescoping boom 1 is attached, which can rotate around a horizontal luffing axis 2 and can be luffed in the normal manner by luffing cylinders. In the embodiment shown, the telescoping boom 1 has two sections, namely the mounting section 3 mounted on the luffing axis 2, as well as the boom section 4, which can telescope out of it. It is, however, understood that the invention is not limited to such two section telescoping booms, but rather telescoping booms with multiple sections are possible.

In the end area opposite the luffing axis 2 of the mounting section 3, a guy support 5 is provided, which can be erected on the back of the telescoping boom 1 (cf. FIG. 1). The guy support 5 consists essentially of two legs 6, which, in the sample embodiment shown, are formed as stiff supports, as well as a rotational frame 7, which forms a support for the two legs 6. The guy support as a unit is pivoted, relative to the telescoping boom 1, around a pivot axis 8, which is transverse to the vertical longitudinal central plane of the telescoping boom 1. As a result, the guy support 5 can be rotated into the vertical stand-off position shown in FIG. 1, as well as into the a transport position essentially on the back of the telescoping boom 1. As FIG. 4 shows, the pivot frame 7 is bolted to the back of the boom section 3 in such a manner that it can pivot, so that it can be rotated around the above-mentioned pivot axis 8 relative to the boom section 3. The pivot frame 7, which consists of multiple beams in the form of a lattice, supports, at its end opposite the pivot axis 8, the two legs 6 of the guy support 5. These are attached to the pivot frame indeed in such a manner that they can pivot around two parallel pivot axes 9, which are at a distance from each other, which extend parallel to the vertical longitudinal central plane through the telescoping boom 1. The legs 6 can be bolted in a simple manner to the pivot frame 7, so that a pivoting movement of the pivot frame 7 is transmitted to the legs 6.

A pair of pressure cylinders 10, which are provided in order to erect the guy support 5 against the telescoping boom 1, are attached with one of their ends to the pivot frame 7 and with their other ends braced against the boom 1. As FIG. 1 shows, the pressure cylinders are attached to the sides of the lower part of boom section 3. The guy support 5 can be laid flat on the back of the telescoping boom 1, as well moved to the erect position shown in FIG. 1, with the aid of the pressure cylinders 10.

The pivot axes 9 between the legs 6 and the pivot frame 7 are assigned pair of pivot cylinders 11, which form a spreading device for the two legs of the guy support 5. The pivot cylinders are connected on the one end with each of the legs. On the other hand, they are attached to the pivot frame 7, as shown in FIG. 4, especially approximately in the area of its pivot axis 8. The legs 6 can be rotated between an approximately parallel position of the two legs and a V-shaped spread-out position, according to FIG. 4. The spread angle between the two legs 6 can be adjusted according to conditions. The maximum spread angle is at least 90 degrees. Preferably, the pivot cylinders 11 are arranged in such a way that in the desired spread position the pivot cylinders 11 are in their completely retracted position and therefore define a limit position. Guy cabling 12 for the telescoping boom is routed over the ends of the legs 6 away from the telescoping boom 1. At one end, guy cables 13 run from the tips of the legs 6 to a head piece on the telescoping boom section 4. As FIG. 1 shows, a cross support 14 is provided on the head of the boom section 4, which extends outward sideways beyond the boom section 4. The guy cables 13 are fastened to the ends of the cross support 14. The mounting points 15 on the cross support 14 are at a distance from the vertical longitudinal plane of the telescoping boom 1, which corresponds to approximately twice the telescoping boom's diameter. Other distances may be chosen. It is also possible to fasten the guy cables 13 directly to a collar on the boom section 4 or to an adapter tip fastened to it.

At the tips of the legs 6, winches 15 are provided, with the aid of which the guy cables 13 can be tensioned, depending upon the length to which the boom section 4 is run out.

Furthermore, the guy cabling 12 includes guy cables or guy elements 16, which are fastened at one end to the tips of the arms 6 and at the other end to the telescoping boom 1 in the area of the luffing axis 1. The length of the guy cables 16 may be chosen to be fixed in such a manner that, when the legs 6 are spread, the guy cables 16 are tensioned, if the guy support 5 is erected into a plane that is perpendicular to the longitudinal axis of the telescoping boom 1 and provides maximum stiffness in this position to the telescoping boom.

FIG. 6 shows a telescoping boom, on the head of which multiple lattice pieces 20 are provided, which extend the telescoping boom. The guy cables 16 are bolted to one or more lattice pieces 20 in order to guy it (cf FIG. 6). Further development of this embodiment can correspond to what is described above.

1. Vehicular crane with a telescoping boom (1) fastened to its bed, as well as guying for the telescoping boom, which has a guy support (5) on a back of the telescoping boom, guy cabling (12) from the guy support (5) to a head (17) or a collar of a telescoping boom section (4), as well as at least one winch (15) to tension the guy cabling (12), where the guy support (5) has two legs (6) that can be spread into a V-shape, whose ends on the boom side are mounted so that they can pivot and whose ends extending away from the telescoping boom can be connected each with a guy cable (13), characterized in that the guy support (5) is formed in such a manner as to be free from transverse stresses between the out-stemming ends (18) of its two legs (6).

2. Vehicular crane according to the foregoing claim, where the boom side ends of the legs (6) are attached to a support piece (7) in such a manner that they can pivot, which again is attached to the telescoping boom (1) in such a manner that it can pivot, where preferably the pivot axis (8) can be rotated around the support piece (7) to the telescoping boom (1), and the axis of rotation or axes of rotation (9) can be rotated around the legs (6) to the support piece (7), into planes that are perpendicular to each other, especially into a plane perpendicular to the longitudinal axis of the telescoping boom (1), as well as into a plane or into two planes parallel to the longitudinal axis of the telescoping boom (1).

3. Vehicular crane according to the foregoing claim, where the support piece (7) is made up of multiple beams as a stiff frame.

4. Vehicular crane according to one of the foregoing claim, where a spreading device (11) is provided to adjust the spread angle between the two legs (6), especially where at least one pressure cylinder (11), which can be rotated with the guy support (5) around a pivot axis (8) perpendicular to the longitudinal direction of the telescoping boom (1), is present.

5. Vehicular crane according to the foregoing claim, where there is assigned to each of the legs (6) a pressure cylinder (11), which is attached at the end to the corresponding leg (6) and at its other end to the support piece (7).

6. Vehicular crane according to one of the foregoing claim, in which an erecting device (10) is provided to adjust an erection angle between the guy support (5) and the longitudinal axis of the telescoping boom (1), which especially has at least one pressure cylinder (10), which on one end is attached to the telescoping boom (1) and on the other end to the support piece (7) for the legs (6).

7. Vehicular crane according one of to the foregoing claim, where the guy cable (13) from the guy support (5) to the head (17) of the telescoping boom section (4) are attached to a cross piece support (14), which has two attachment points (19) that are at a distance to the side from the boom section (4).

8. Vehicular crane according to one of the foregoing claim, where the guy cables (13) are connected from the guy support (5) to the telescoping boom section (4) at its collar or to a luffing tip adapter attached to it.

9. Vehicular crane according to one of the foregoing claim, wherein, at each of the legs (6), a winch (15) is provided to tension the guy cable (13), leading to this leg (6).
